(19) United States
(12) Patent Application Publication
(10) Pub. No.: US 2018/0255836 A1
(43) Pub. Date: Sep. 13, 2018

(54) CHILD-PROOF ATOMIZER AND ELECTRONIC CIGARETTE HAVING CHILD-PROOF ATOMIZER

(71) Applicant: CHANGZHOU JWEI INTELLIGENT TECHNOLOGY CO., LTD., Changzhou (CN)

(72) Inventor: WEI-HUA QIU, ChangZhou (CN)

(21) Appl. No.: 15/979,479

(22) Filed: May 15, 2018

Related U.S. Application Data
(63) Continuation-in-part of application No. PCT/CN2016/104179, filed on Nov. 1, 2016.

(30) Foreign Application Priority Data
Nov. 19, 2015 (CN) 201510802896.X
Nov. 19, 2015 (CN) 201520927082.4

(51) Int. Cl. A24F 47/00; H05B 3/46

(52) U.S. Cl. CPC A24F 47/008; H05B 2203/021; H05B 3/46

(57) ABSTRACT

A childproof atomizer and an electronic cigarette therewith are disclosed. The atomizer comprises a lower cover assembly, a liquid storage assembly arranged at an end of the lower cover assembly, and a latching assembly. The latching assembly comprises a first receiving space formed in the lower cover assembly, a second receiving space formed in the liquid storage assembly, and a latching member. The first receiving space communicates with the second receiving space. The latching member is received in the first receiving space and the second receiving space and locks the lower cover assembly and the liquid storage assembly together in an unlockable way. When the latching member is separated from the first receiving space and/or the second receiving space, the lower cover assembly and the liquid storage assembly are unlocked.

### FIELD

The subject matter herein generally relates to electronic cigarette field, and particularly to an atomizer and an electronic cigarette having the atomizer.

### BACKGROUND

Electronic cigarette as substitute for cigarette is popular. The structure of a general electronic cigarette atomizer is simple, and the atomizer can be disassembled by simple operations. Sometimes children can get the electronic cigarette and disassemble the atomizer, so they can mess with the tar or other substances similar to tobacco tar, which are stored in an atomizing chamber of the atomizer.

### BRIEF DESCRIPTION OF THE DRAWINGS

Implementations of the present technology will now be described, by way of example only, with reference to the attached figures.

FIG. 1 is a schematic view of an atomizer, in accordance with a first exemplary embodiment of the present application.

FIG. 2 is a cross-sectional view along the direction of A-A of FIG. 1 in a locked state.

FIG. 3 is a cross-sectional view along the direction of A-A of FIG. 1 in an unlocked state.

FIG. 4 is a stereoscopic, exploded view of the atomizer of FIG. 1 without an atomizing head.

FIG. 5 is a stereoscopic view of a lower cover assembly with a coupling member.

FIG. 6 is a stereoscopic view of a lower cover connecting member.

FIG. 7 is a stereoscopic view of a lower cover with the coupling member.

FIG. 8 is a stereoscopic view of an atomization chamber base with the coupling member.

FIG. 9 is a schematic view of an electronic cigarette having the atomizer shown in FIG. 1.

FIG. 10 is a schematic view of an atomizer, in accordance with a second exemplary embodiment of the present application.

FIG. 11 is a schematic view of the atomizer of FIG. 10 without a coupling member.

FIG. 12 is an enlarged, schematic view of part A of FIG. 11.

FIG. 13 is a schematic view of an atomizer in accordance with a third exemplary embodiment of the present application.

FIG. 14 is a schematic view of the atomizer of FIG. 13 without a coupling member.

FIG. 15 is an enlarged, schematic view of part B of FIG. 14.

FIG. 16 is a schematic view of an atomizer in accordance with a fourth exemplary embodiment of the present application.

FIG. 17 is a schematic view of the atomizer shown in FIG. 16 in a locked state.

FIG. 18 is a schematic view of the locked atomizer shown in FIG. 16 in an unlocked state.

FIG. 19 is a cross-sectional view along the direction of B-B of FIG. 18.

FIG. 20 is a schematic view of an electronic cigarette having the atomizer shown in FIG. 16.

FIG. 21 is a schematic view of an atomizer in an unlocked state in accordance with a fifth exemplary embodiment of the present application.

FIG. 22 is a schematic view of the atomizer shown in FIG. 21 in a locked state.

FIG. 23 is a schematic view of an electronic cigarette having the atomizer shown in FIG. 21.

### DETAILED DESCRIPTION

Detailed description of specific embodiments of the present application will be given with reference to the accompanying drawings. A number of specific details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

It should be noted that, when an element is considered to be “fixed to” another element, which can be either directly fixed on another element or indirectly fixed on another element with a centered element. When an element is considered to be “coupled with” another element, it can be either directly coupled with another element or indirectly coupled with another element.

Unless otherwise defined, all technical and scientific terms used herein have the same meaning as commonly understood by one skilled in the art. The terms used in a specification of the present application herein are only for describing specific embodiments, and are not intended to limit the present application. The terms “and/or” used herein includes any and all combinations of one or more of associated listed items.

A first embodiment is as follows.

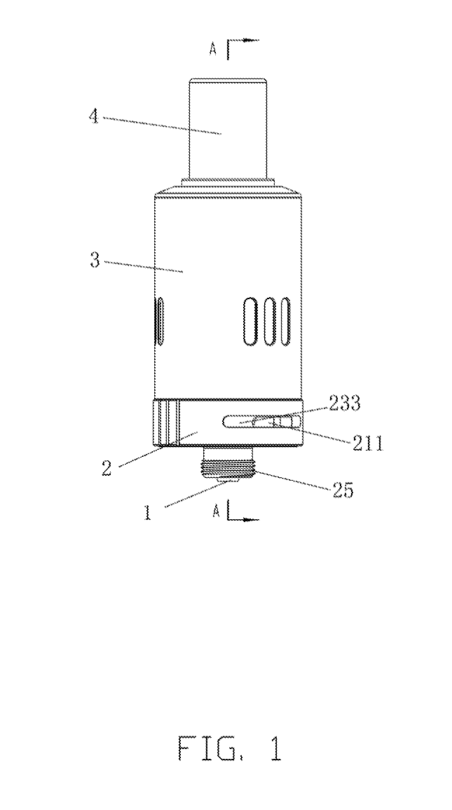

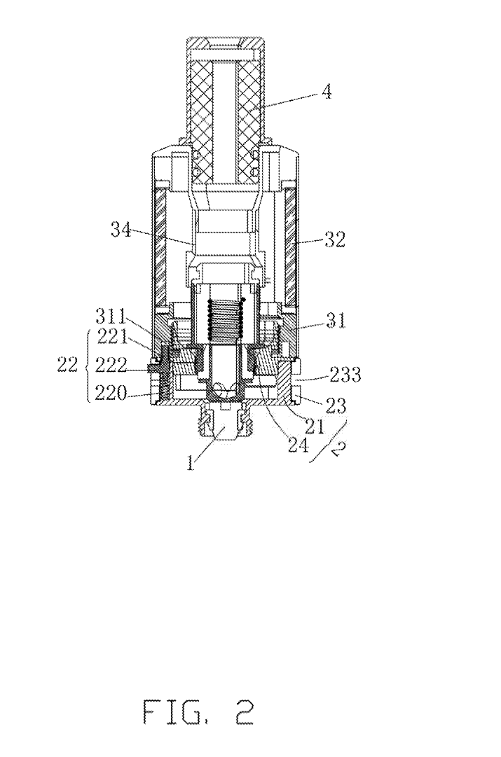

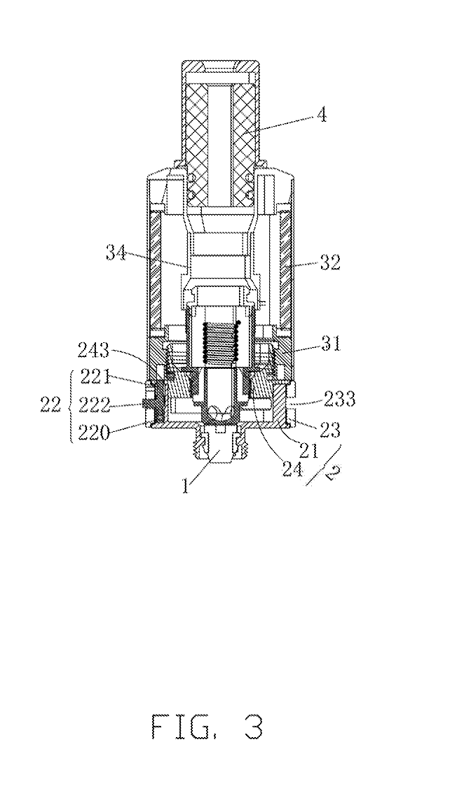

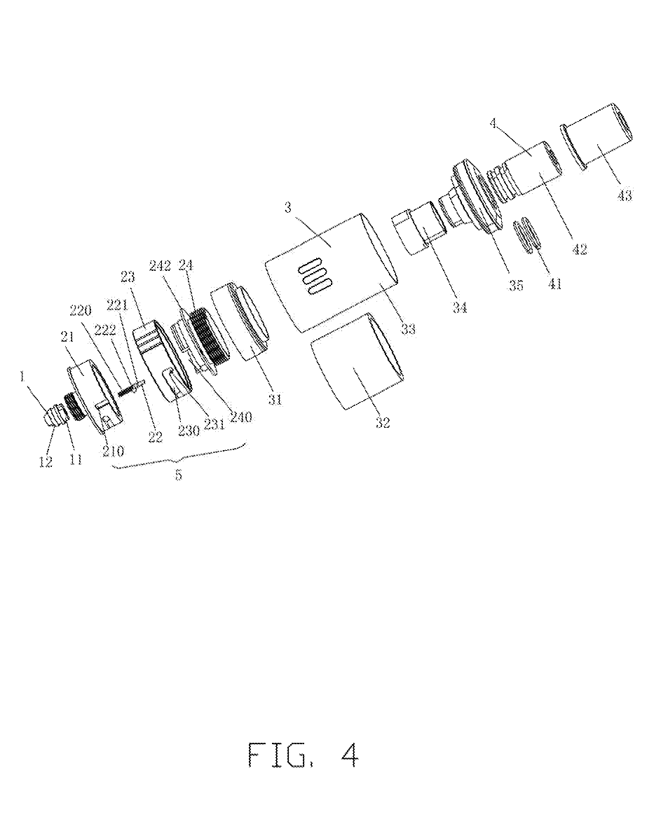

Referring to FIGS. 1, 2, 3 and 4, the first embodiment of the present application provides an atomizer with non-access function. The atomizer includes an electrical contacting assembly 1, a lower cover assembly 2, a liquid storage assembly 3, and a suction nozzle assembly 4. The electrical contacting assembly 1 is positioned at an end of the lower cover assembly 2. The liquid storage assembly 3 is positioned at another end of the lower cover assembly 2. An end of the liquid storage assembly 3 away from the electrical contacting assembly 1 is connected with the suction nozzle 4.

The electrical contacting assembly 1 includes a positive electrode contacting member 11 and an insulation member 12 sleeved on the positive electrode contacting member 11. The insulation member 12 is positioned on the periphery of the positive electrode contacting member 11.

The lower cover assembly 2 includes a lower cover 21, a screw cap 23 coupled to the lower cover 21, and a lower cover connecting member 24 coupled to the screw cap 23. The lower cover 21 is substantially a tubular member. The electrical contacting assembly 1 is adjacent to a bottom of the lower cover 21 and received in the lower cover 21. The screw cap 23 is sleeved on the lower cover 21, to form part of outline of the atomizer. The lower cover connecting member 24 is arranged at an end of the lower cover 21 opposite to electrical contacting assembly 1. The periphery 242 of the lower cover connecting member 24 abuts against an inner step surface at a top portion of the screw cap 23. The screw cap 23 can be rotated around the lower cover 21 and the lower cover connecting member 24.

The liquid storage assembly 3 includes an atomization chamber base 31, a liquid storage tube 32, an outer tube 33, an atomizer bushing 34, and an atomization chamber liquid storage cover 35. The liquid storage tube 32 is arranged on the atomization chamber base 31. The outer tube 33 is positioned on the periphery of the atomization chamber base 31 and the liquid storage tube 32. The atomizer bushing 34 is received in the liquid storage tube 32, and the atomization chamber liquid storage cover 35 is coupled to the atomizer bushing 34. The atomization chamber base 31 is fixed to the lower cover connecting member 24 via internal threads of the atomization chamber base 31. In the illustrated embodiment, the liquid storage tube 32 is made of transparent or translucent material, such as glass, plastic and so on. The outer tube 33 is made of metal, and a viewing window is arranged on the outer tube 33 to observe the tobacco tar in the liquid storage assembly 3.

The suction nozzle assembly 4 includes a suction nozzle liner 42, a sealing ring 41 arranged on the suction nozzle liner 42, and a suction nozzle outer cover 43 covering the suction nozzle liner 42. An interconnected suction hole is positioned between the suction nozzle liner 42 and the suction nozzle outer cover 43. The interconnected suction hole forms a part of user suction channel.

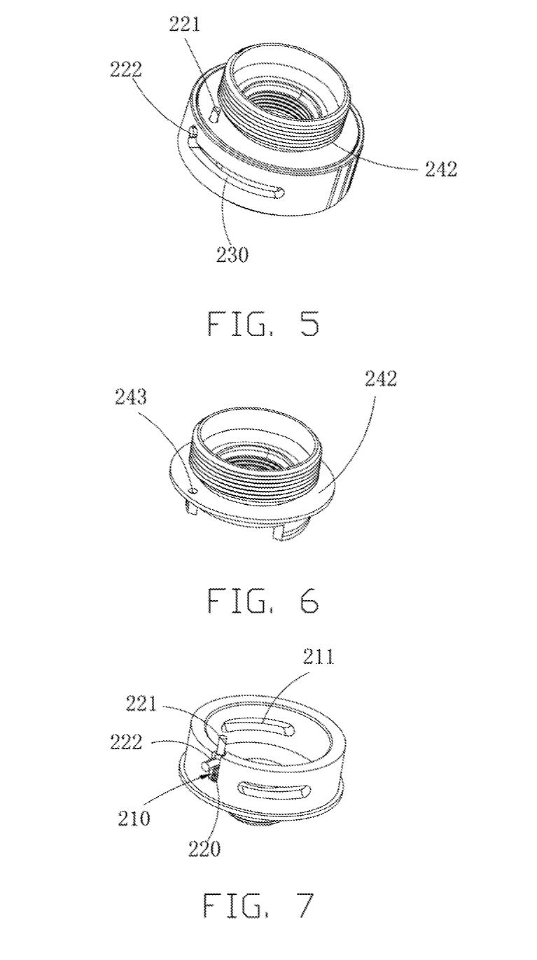

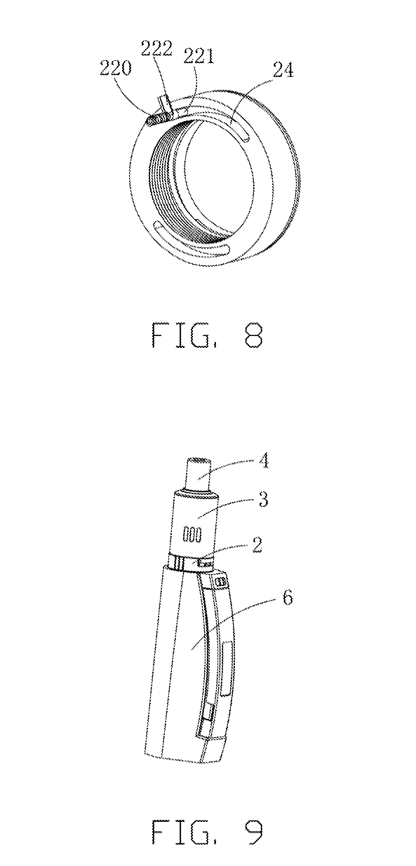

Referring to FIGS. 5, 6, 7 and 8, the atomizer further includes a latching assembly 5. The latching assembly 5 is mounted to the lower cover assembly 2 and the liquid storage assembly 3. The latching assembly 5 is configured to lock the lower cover assembly 2 and the liquid storage assembly 3 in an unlockable way. The latching assembly 5 defines a first receiving space 210, a through groove 230, a receiving groove 231 communicating with the through groove 230, a latching member 22, a mating hole 243, and a second receiving space 311. The latching member 22 is received in the receiving groove 231 and the first receiving space 210, and the latching member 22 can be elastically moved upwardly and downwardly. A top end portion of the latching member 22 passes through the mating hole 243, and is latched to the second receiving space 311.

The first receiving space 210 is defined longitudinally along an outer wall of lower cover 21, and the first receiving space 210 is adjacent to an opening at a top end portion of the lower cover 21.

The through groove 230 is defined along a circumferential direction of the screw cap 23. The receiving groove 231 is defined on a sidewall of the screw cap 23 adjacent to the lower cover connecting member 24. The through-groove 230 and the receiving groove 231 cooperatively form an L-shaped groove.

The mating hole 243 is defined on the periphery 242 of the lower cover connecting member 24, and the mating hole 243 is aligned with a top end of the first receiving space 210.

The second receiving space 311 is defined on a bottom end surface of the atomization chamber base 31.

The latching member 22 is coupled to the lower cover 21, and the latching member 22 is positioned between the lower cover 21 and the screw cap 23. The latching member 22 includes a spring 220, a pin bolt 221, and a protruding portion 222. The spring 220 is received in the first receiving space 210. A bottom end portion of the pin bolt 221 is inserted into the spring 220, a top end portion of the pin bolt 221 passes through the mating hole 243 and is latched to the second receiving space 311. The protruding portion 222 is positioned in the receiving groove 231, and the protruding portion 222 can be moved upwardly and downwardly in the receiving groove 231. The protruding portion 222 is positioned between the spring 220 and the pin bolt 221, and the protruding portion 222 protrudes outwardly from a circumference surface of the pin bolt 221. The protruding portion 222 can be received in the through-groove 230 and the receiving groove 231. When the protruding portion 222 is pressed, the spring 220 is compressed. Then the screw cap 23 is rotated, and the through groove 230 is rotated together with the rotation of the screw cap 23, to enable the protruding portion 222 to latch into the through groove 230. When the screw cap 23 is rotated in an opposite direction, the spring 220 is released, and the protruding portion 222 is latched into the receiving groove 231 again. In the illustrated embodiment, the second receiving space 311 is an arcuate groove with a certain length, which is defined along a circumference direction, to increase an accuracy of a top end portion of the pin bolt 221 sliding into the groove, and to prevent the pin bolt 231 from being disengaged.

Furthermore, the latching assembly 5 includes an air inlet 211 defined on the lower cover 21. The air inlet 211 is defined along the circumference direction of the lower cover 21, and the air inlet 211 is positioned opposite to the through groove 230. When the latching member 22 is in an unlocked state, the breathing area between the air inlet 211 and the through groove 230 can be adjusted by moving the screw cap 23, to adjust the airflow of the atomizer.

In an alternative embodiment, a quantity of the air inlet 211 can be two or more than two. The through groove 230 can correspond to one of the air inlets 211, to adjust a breathing area of the air inlet 211. When breathing areas of other air inlets 211 need to be adjusted, other adjustable holes 233 defined on the screw cap 23 corresponding to the other air inlets 211 are needed.

Furthermore, the latching assembly 5 further includes a gap 240 defined on a bottom sidewall of the lower cover connecting member 24, and the gap 240 communicates with an opening at a bottom end portion of the lower cover connecting member 24. When the external air flows into the air inlet 211, the external air can flow into the atomization head via the gap 240.

In use, when the protruding portion 222 is received in the receiving groove 231, the top end portion of the pin bolt 221 passes through the mating hole 243 and latches to the second receiving space 311, so that the lower cover connecting member 24 is locked with the atomization chamber base 31. The lower cover assembly 2 is locked with the liquid storage assembly 3. When the atomizer needs to be separated by rotating the screw cap 23, such as the atomization head needs to be changed, the protruding portion 222 can be pressed to compress the spring 220. Then the screw cap 23 can be rotated and the through groove 230 can be rotated with the screw gap, such that the protruding portion 222 is latched to the through groove 230. Thus, the protruding portion 222 can be moved away from the second receiving space 311, and the lower cover connecting member 24 can be unlocked with the atomization chamber base 31. Therefore, the lower cover assembly 2 is unlocked from the liquid storage assembly 3, to change the atomization head.

In the other embodiments, the though groove 230 and the receiving groove 230 are not limited to the shape of an L-shaped groove. For example, the though groove 230 and the receiving groove 230 can form grooves of other shapes or structures, such as an S-shaped groove, Z-shaped groove or a labyrinth shaped groove, to lock or unlock the latching member 22.

In an alternative embodiment, when the latching member 22 is an elastic element, the spring 220 can be omitted.

In an alternative embodiment, the through-groove 230 can be omitted. The protruding portion 222 can be pressed (such as by a finger of a user) to move the latching member 22 downward to disengage from the second receiving space 311, so that the lower cover connecting member 24 is unlocked from the atomization chamber base 31. The lower cover assembly 2 is unlocked from the liquid storage assembly 3 to change the atomization head. When a pressure on the protruding portion 222 is removed, the latching member 22 is received to the second receiving space again, and the atomizer is locked.

A second embodiment is as follows.

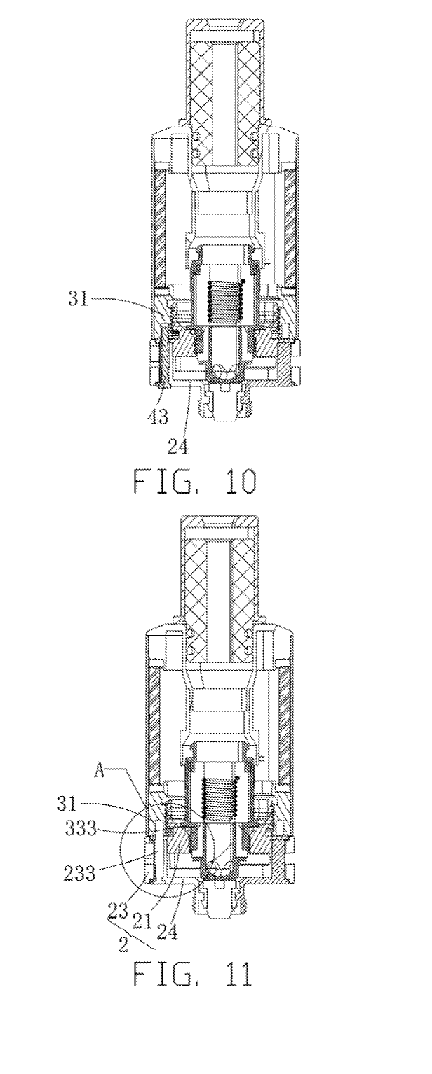

Referring to FIGS. 10, 11 and 12, the structure and installation of the latching assembly are different from those of the first embodiment. In this embodiment, the latching assembly 5 includes a first receiving space 233, a latching member 43, and a second receiving space 333. The first receiving space 233 communicates with the second receiving space 333 to receive the clamping member 43 in a detachable way. The first receiving space 233 is defined on the lower cover assembly 2 along an axial direction, and the first receiving space 233 passes through the lower cover 21 and the lower cover connecting member 24 in that order. The second receiving space 333 is defined on the atomization chamber base 31 along an axial direction.

When the lower cover assembly 2 and the liquid storage assembly 3 need to be unlocked, the latching member 43 can be removed from the second receiving space 333. Therefore, the latching member 43 can be separated from the atomizer.

A third embodiment is as follows.

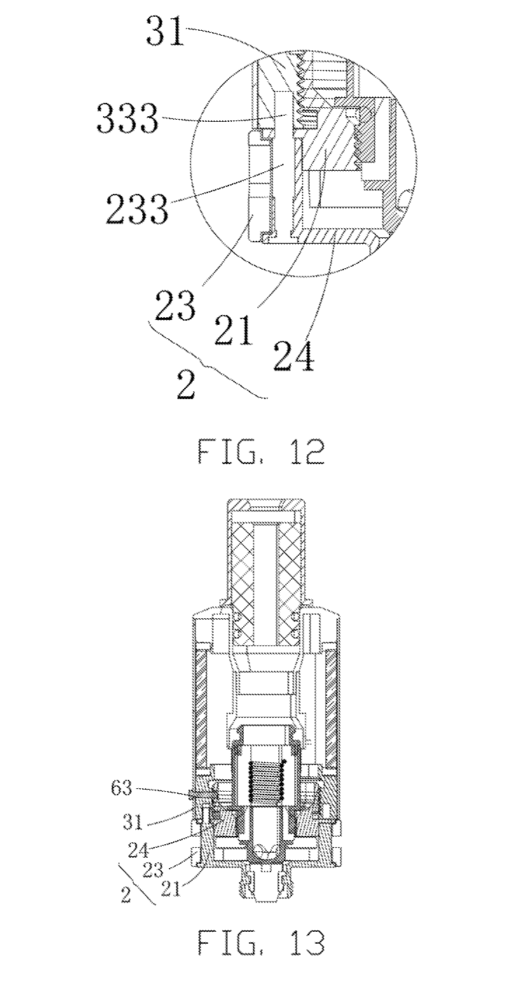

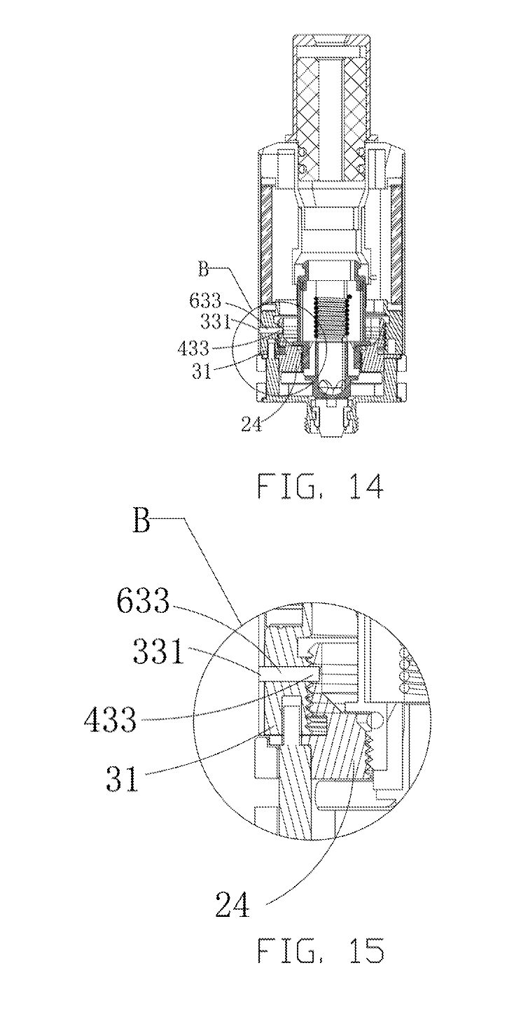

Referring to FIGS. 13, 14 and 15, the structure and installation of the latching assembly 5 are different from those of the second embodiment. In this embodiment, the latching assembly 5 includes a first receiving space 433, a latching member 63, and a second receiving space 633. The first receiving space 433 communicates with the second receiving space 633, to receive the latching member 63 in a detachable way. The first receiving space 433 is defined on the lower cover assembly 2 along a radial direction. The first receiving space 433 passes through the lower cover connecting member 24. The second receiving space 633 is defined on the atomization chamber base 31 along a radial direction. In order to allow the latching member 63 to latch to the second receiving space 633 and the first receiving space 433, a through hole 331 is defined on the outer tube 33. The through hole 331 communicates with the second receiving space 633 and the first receiving space 433. So that the lower cover assembly 2 and the liquid storage assembly 3 can be coupled in an unlockable way, the defining directions of the first receiving space 433 and the second receiving space 633 are not limited to a certain radial direction or axial direction. An included angle of the first receiving space and the second receiving space can be 45 degrees.

In the first embodiment, the second embodiment, and the third embodiment, the latching assembly 5 is coupled to the lower cover assembly 2 and the liquid storage assembly 3 of the atomizer in an unlockable way. When the atomizer needs to be disassembled, several complex operations are needed to open the latching assembly 5, to prevent access by children. Therefore, children cannot touch the tobacco tar or other substances similar to tobacco tar, which are stored in an atomizing chamber of the atomizer.

Referring to FIG. 9, the present disclosure further provides an electronic cigarette having the atomizer. The electronic cigarette further includes a battery assembly 6 coupled to an end of the atomizer opposite to the suction nozzle assembly 4. The battery assembly 6 is configured to supply power to the atomizer.

A fourth embodiment is as follows.

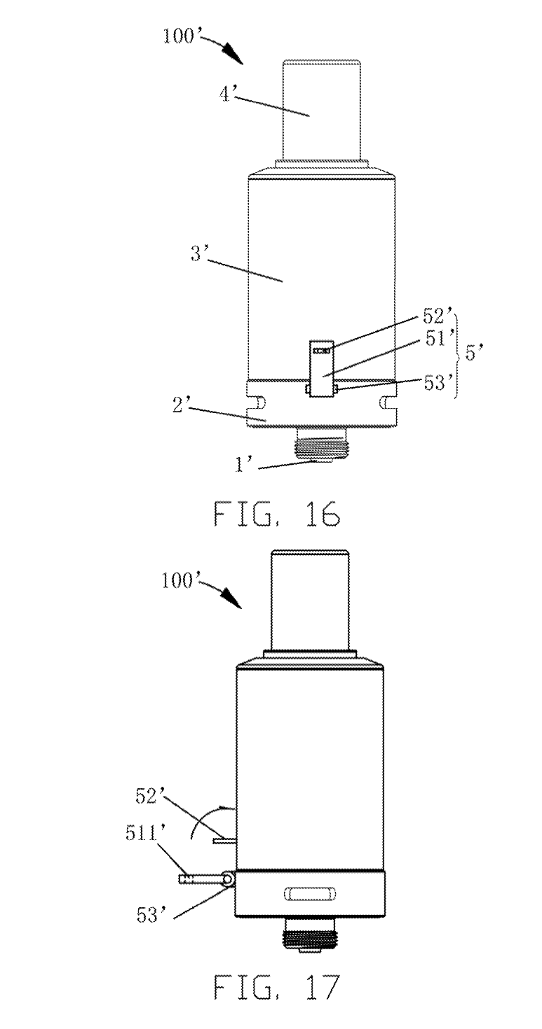

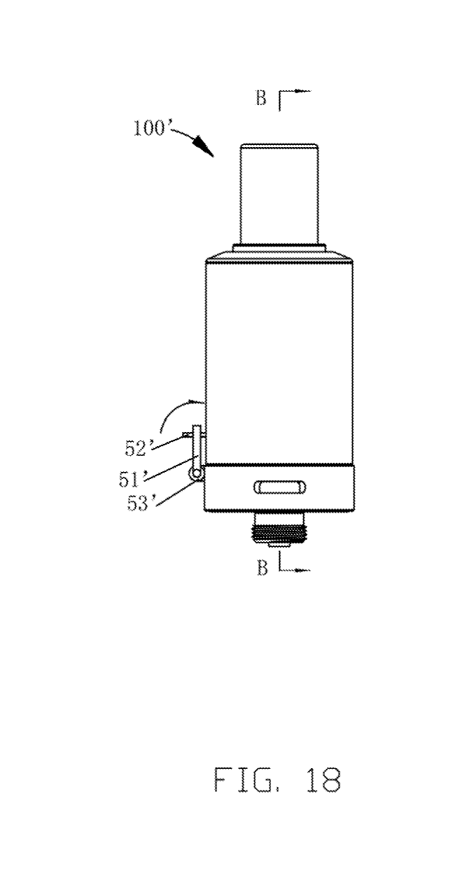

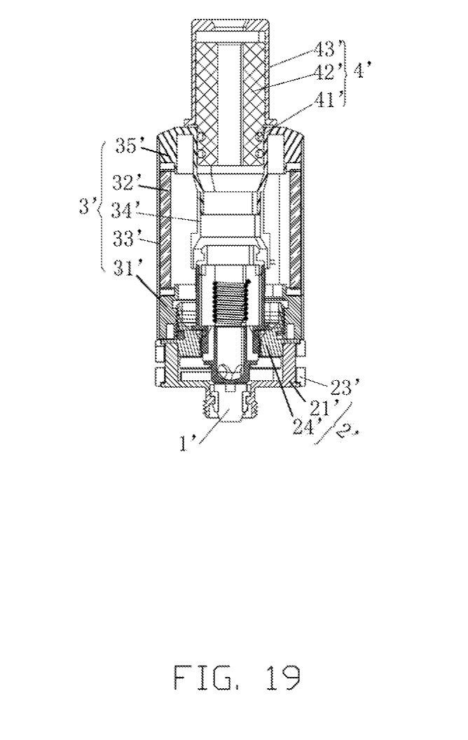

Referring to FIGS. 16, 17, 18 and 19, the atomizer 100′ with non-access function includes an electrical contacting assembly 1′, a lower cover assembly 2′, a liquid storage assembly 3′ and a suction nozzle assembly 4′. The electrical contacting assembly 1′ is positioned at an end of the lower cover assembly 2′. The liquid storage assembly 3′ is positioned at another end of the lower cover assembly 2′. An end of the liquid storage assembly 3′ away from the electrical contacting assembly 1′ is connected with the suction nozzle 4′.

The lower cover assembly 2′ includes a lower cover 21′, a screw cap 23′, and a lower cover connecting member 24′. The screw cap 23′ is coupled to the lower cover 21′, and the lower cover connecting member 24′ is coupled to the screw cap 23′. The lower cover 21′ is a substantially tubular part. The electrical contacting assembly 1′ is positioned adjacent to the bottom of the lower cover 21′ and received in the lower cover 21′. The screw cap 23′ is sleeved on the lower cover 21′, to form a part of an outline of the atomizer 100′. The lower cover connecting member 24′ is arranged at an end of the lower cover 21′ opposite to the electrical containing assembly 1′. The periphery of the lower cover connecting member 24′ abuts against the inner step surface at a top portion of the screw cap 23′. The screw cap 23′ can be rotated around the lower cover 21′ and the lower cover connecting member 24′.

The liquid storage assembly 3′ includes an atomization chamber base 31′, a liquid storage tube 32′, an outer tube 33′, an atomizer bushing 34′, and an atomization chamber liquid storage cover 35′. The liquid storage tube 32′ is arranged on the atomization chamber base 31′. The outer tube 33′ is sleeved on the atomization chamber base 31′ and the liquid storage tube 32′. The atomizer bushing 34′ is received in the liquid storage tube 32′. The atomization chamber liquid storage cover 35′ is coupled to the atomizer bushing 34′. The outer tube 33′ forms a part of the outline of the atomizer 100′. The atomization chamber base 31′ is connected with the lower cover connecting member 24′ in a detachable way via internal threads. In the illustrated embodiment, the liquid storage tube 32′ is made of transparent or translucent material, such as glass, plastic and so on. The outer tube 33′ is made of metal, and a viewing window is arranged on the outer tube 33′ to observe the tobacco tar in the liquid storage assembly 3′.

The suction nozzle assembly 4′ includes a suction nozzle liner 42′, a sealing ring 41′ arranged on the suction nozzle liner 42′, and a suction nozzle outer cover 43′ covering the suction nozzle liner 42′. An interconnected suction hole is positioned between the suction nozzle liner 42′ and the suction nozzle outer cover 43′. The interconnected suction hole forms a part of user suction channel.

The atomizer 100′ further includes a latching assembly 5′. The latching assembly 5′ is mounted to the lower cover assembly 2′ and the liquid storage assembly 3′. The latching assembly 5′ is configured to lock the lower cover assembly 2′ and the liquid storage assembly 3′ together in an unlockable way. The latching assembly 5′ includes a coupling member 51′ and a locking portion 52′. The locking portion 52′ is locked with the coupling member 51′ in an unlockable way. An end of the coupling member is rotatably mounted to the lower cover assembly 2′. The locking portion 52′ is positioned on the liquid storage assembly 3′ and extends outwardly from the liquid storage assembly 3′. A latching portion 511′ is defined on the coupling member 51′, and the latching portion 511′ can be coupled with the locking portion 52′ in an unlockable way. The latching portion 511′ can be a slot or a latching hole. In the embodiment, the latching portion 511′ is a latching hole.

Furthermore, the latching assembly 5′ further includes a connecting member 53′ mounted to the lower cover assembly 2′. The coupling member 51′ is mounted to the lower cover assembly 2′ via the connecting member 53′, and the coupling member 51′ can be rotated upwardly and downwardly. The connecting member 53′ can be a rotating shaft structure or a hinging structure. When the coupling member 51′ is rotated upwardly toward the liquid storage assembly 3′ and around the connecting member 53′, the locking portion 52′ can pass through the latching portion 511′. The lower cover assembly 2′ and the liquid storage assembly 3′ are locked together via the locking portion 52′. When the coupling member 51′ is rotated downwardly away from the liquid storage assembly 3′, the lower cover assembly 2′ and the liquid storage assembly 3′ are separated. In other words, when the coupling member 51′ is rotated around the connecting member 53′ upwardly or downwardly, the lower cover assembly 2′ can be locked with or unlocked from the liquid storage assembly 3′.

Furthermore, the coupling member 51′ is rotatably mounted to the screw cap 23′. The locking portion 52′ is positioned on the outer tube 33′.

In use, when the latching portion 511′ and the locking portion 52′ are in the locked state, the lower cover assembly 2′ and the liquid storage assembly 3′ are locked together. When the atomizer 100′ needs to be separated by rotating the screw cap 23′, such as the atomization head needs to be changed, the coupling member 51′ can be moved away from the liquid storage assembly 3′ to unlock the latching portion 511′ and the locking portion 52′. The lower cover assembly 2′ is unlocked from the liquid storage assembly 3′. Therefore, the lower cover assembly 2′ is detached via the screw cap 23′, to change the atomization head.

In an alternative embodiment, the latching portion 511′ can be an extending portion protruding towards the liquid storage assembly 3′. The locking portion 52′ can be a slot or a latching hole, which is defined opposite to the extending portion. The extending portion can be received in and latched into the slot or the latching hole.

Referring to FIG. 20, the present disclosure provides an electronic cigarette 300′ having the atomizer 100′. The electronic cigarette 300′ further includes a battery assembly 310′. The battery assembly 310′ is mounted to an end of the atomizer 100′ opposite to the suction nozzle 4′. The battery assembly 310′ is configured to supply power of the atomizer 100′.

A fifth embodiment is as follows.

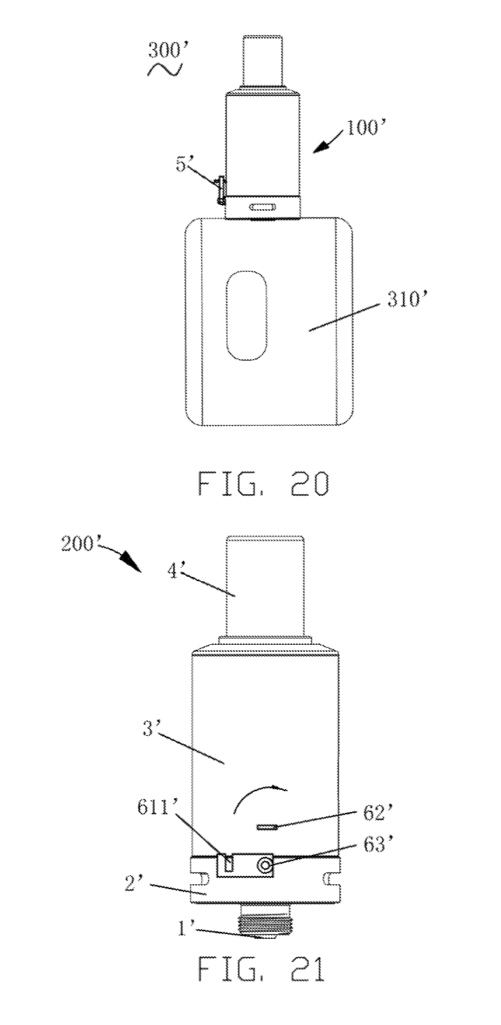

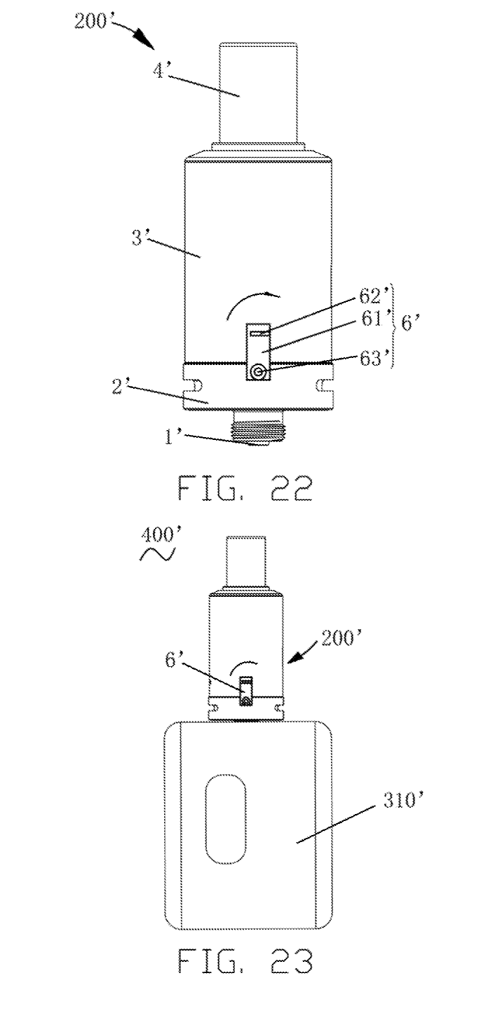

Referring to FIGS. 21 and 22, the structure and installation of the latching assembly are different from those of the fourth embodiment. In this embodiment, the latching assembly 6′ includes a coupling member 61′ and a locking portion 62′ matched with the coupling member 61′. An end of the coupling member 61′ is rotatably mounted to the lower cover assembly 2′. The locking portion 62′ is positioned on the liquid storage assembly 3′, and extends outwardly from the liquid storage assembly 3′. A latching portion 611′ is defined on the coupling member 61′ to lock the locking portion 62′ in an unlockable way. The latching portion 611′ is a slot or a latching hole. In this illustrated embodiment, the latching portion 611′ is a slot passing through the distal end of the coupling member 61′.

The latching assembly 6′ further includes a connecting member 63′ mounted to the lower cover assembly 2′. The coupling member 61′ is rotatably mounted to the lower cover assembly 2′ via the connecting member 63′. The connecting member 63′ is a hinging structure or a rotating shaft structure. When the coupling member 61′ is rotated clockwise around the connecting member 63′, and adjacent to the liquid storage assembly 3′, the locking portion 62′ passes through the latching portion 611′. The lower cover assembly 2′ and the liquid storage assembly 3′ are locked together via the locking portion 62′. When the coupling member 61′ is rotated anticlockwise around the connecting member 63′, and away from the liquid storage assembly 3′, the lower cover assembly 2′ is unlocked from the liquid storage assembly 3′. The coupling member 61′ can be rotated clockwise or anticlockwise around the connecting member 63′ to lock or unlock the lower cover assembly 2′ and the liquid storage assembly 3′.

In an alternative embodiment, the relative positions of the coupling member 61′ and the locking portion 62 are interchangeable. The coupling member 62′ is rotatably mounted to the liquid storage assembly 3′, and the locking portion 62′ is defined on the lower cover assembly 2′.

In an alternative embodiment, the latching portion 611′can be an extending portion protruding towards the liquid storage assembly 3′. The locking portion 62′ can be a slot or a latching hole, and defined so as to be opposite to the extending portion. The extending portion can be received in and latched into the locking portion 62.

Referring to FIG. 23, the present disclosure provides an electronic cigarette 400′ having the atomizer 200′. The electronic cigarette 400′ further includes a battery assembly 310′ coupled to an end of the atomizer 200′ opposite to the suction nozzle assembly 4′. The battery assembly 310′ is configured to supply the power of the atomizer 200′.

The latching assembly 5′, 6′ is detachably positioned on the lower cover assembly 2′ of the atomizer 100′,200′ and the liquid storage assembly 3′ of the atomizer 100′, 200′. When the atomizer 100′, 200′ needs to be separated, the latching assembly 5′, 6′ needs to be detached first, barring children from detaching the atomizer 100′, 200′ by accident. Therefore, children cannot touch the tobacco tar or other substances similar to tobacco tar, which are stored in an atomizing chamber of the atomizer.

The embodiments shown and described above are only examples. Many details are often found in the art such as the other features of atomizers. Therefore, many such details are neither shown nor described. Even though numerous characteristics and advantages of the embodiments have been set forth in the foregoing description, together with details of the structure and function of the embodiments, the present disclosure is illustrative only, and arrangement of parts within the principles of the embodiments to the full extent indicated by the broad general meaning of the terms in which the appended claims are expressed.

What is claimed is:

1. An atomizer comprising a lower cover assembly, a latching assembly, and a liquid storage assembly arranged at an end of the lower cover assembly, the latching assembly comprising a latching member, the lower cover assembly defining a first receiving space, the liquid storage assembly defining a second receiving space in communication with the first receiving space, wherein when the latching member is received in the first receiving space and the second receiving space, the lower cover assembly and the liquid storage assembly being locked; when the latching member is separated from the first receiving space or the second receiving space, the lower cover assembly and the liquid storage assembly being unlocked.

2. The atomizer as claimed in claim 1, wherein the lower cover assembly comprises a lower cover and a lower cover connecting member, the first receiving space is arranged on the lower cover and/or the lower cover connecting member, the liquid storage assembly comprises an atomization chamber base, the second receiving space is defined at the atomization chamber base.

3. The atomizer as claimed in claim 2, wherein the lower cover connecting member defines a mating hole, the first receiving space is defined longitudinally along a sidewall of lower cover, and the first receiving space is positioned adjacent to an opening of a top end portion of the lower cover, the second receiving space is positioned at a bottom end surface of atomization chamber base, a bottom end portion of the latching member is received in the first receiving space, a top end portion of the latching member passes through a mating hole defined on the lower cover connecting member and extends to the second receiving space.

4. The atomizer as claimed in claim 3, wherein the lower cover assembly comprises a screw cap coupled to the lower cover, the screw cap defines a receiving groove, the latching member comprises a pin bolt and a protruding portion, a bottom end portion of the pin bolt is received in the first receiving space, and a top end portion of the pin bolt passes through the mating hole and extends to the second receiving space, the protruding portion is coupled to the pin bolt, and capable of driving the pin bolt to move upwardly and downwardly in the receiving groove.

5. The atomizer as claimed in claim 4, wherein a through groove is defined along a circumferential direction of the screw cap, and the through-groove is similar to the receiving groove.

6. The atomizer as claimed in claim 5, wherein the though groove and the receiving groove cooperatively form an L-shaped groove, or an S-shaped groove, or a Z-shaped groove, or a labyrinth-shaped groove.

7. The atomizer as claimed in claim 6, wherein an air inlet is defined along a circumferential direction of the lower cover, and the air inlet is positioned opposite to the through groove, when the latching member is in an unlocked state, the breathing area between the air inlet and the through groove can be adjusted by rotating the screw cap, to adjust an airflow of the atomizer.

8. The atomizer as claimed in claim 7, wherein a gap is defined at a bottom wall of the lower cover connecting member, the gap communicates with an opening of the bottom end portion of the lower cover, and the air inlet communicates with the gap.

9. The atomizer as claimed in claim 3, wherein the second receiving space is an arcuate groove with a certain length, which is defined at a bottom end surface of the atomization chamber base along the circumferential direction.

10. The atomizer as claimed in claim 4, wherein the latching member further comprises a spring received in the first receiving space, a bottom end portion of the pin bolt is inserted into the spring; the protruding portion is positioned between the spring and the pin bolt, and the protruding portion protrudes outwardly from a circumference surface of the pin bolt.

11. An electronic cigarette comprising an atomizer, the atomizer comprising a lower cover assembly, a latching assembly, and a liquid storage assembly arranged at an end of the lower cover assembly, the latching assembly comprising a latching member, the lower cover assembly defining a first receiving space, the liquid storage assembly defining a second receiving space in communication with the first receiving space, wherein when the latching member is received in the first receiving space and the second receiving space, the lower cover assembly and the liquid storage assembly being locked; when the latching member is separated from the first receiving space or the second receiving space, the lower cover assembly and the liquid storage assembly being unlocked.

12. An atomizer comprising a lower cover assembly, a latching assembly, and a liquid storage assembly arranged at an end of the lower cover assembly, the latching assembly being capable of detachably locking the lower cover assembly and the liquid storage assembly together, the latching assembly comprising a coupling member and a locking portion, the coupling member being capable of detachably coupling with the locking portion, the coupling member being rotatably mounted to one of the lower cover assembly or the liquid storage assembly, the locking portion being mounted to another one of the liquid storage assembly or the lower cover storage, when the coupling member is separated from the locking portion, the lower cover assembly and the liquid storage assembly being unlocked.

13. The atomizer as claimed in claim 12, wherein the latching member comprises a latching portion, the latching portion is capable of being locked with the locking portion in an unlockable way.

14. The atomizer as claimed in claim 13, wherein the locking portion extends outwardly from the liquid storage assembly or the lower cover assembly, the latching portion defines a slot or a latching hole.

15. The atomizer as claimed in claim 13, wherein the latching portion comprising an extending portion protruding towards the liquid storage assembly or the lower cover assembly, the locking portion is positioned opposite to the extending portion, the locking portion defines a slot or a latching hole opposite to the extending portion, the slot or the latching hole is configured to receive and latch to the extending portion.

16. The atomizer as claimed in claim 14, wherein the latching portion defines a through hole.

17. The atomizer as claimed in claim 14, wherein the latching portion defines a through groove, and the through groove passes through a distal end of the coupling member.

18. The atomizer as claimed in claim 12, wherein the lower cover assembly comprises a screw cap, the liquid storage assembly comprises an outer tube, the screw cap and the outer tube forms a part of the atomizer's external profile; an end of the coupling member is rotatably mounted to the screw cap or the outer tube, the locking portion is coupled to the outer tube or the screw cap.

19. The atomizer as claimed in claim 12, wherein the latching assembly comprises a connecting member, the connecting member of the coupling member is rotatably coupled to the lower cover assembly or the liquid storage assembly.

20. The atomizer as claimed in claim 19, wherein the connecting member comprises a rotation shaft structure or a hinge structure.
